(19) United States
(12) Patent Application Publication
(10) Pub. No.: US 2025/0029112 A1
(43) Pub. Date: Jan. 23, 2025

(54) APPARATUSES, SYSTEMS, METHODS, AND COMPUTER PROGRAM PRODUCTS FOR LEGACY-BASED AUTOMATED CUSTOMER ASSISTANCE

(71) Applicant: Wells Fargo Bank, N.A., San Francisco, CA (US)

(72) Inventors: Naga Jyothi Avusingi, Hyderabad (IN); Shanmukeswara Rao Donkada, Hyderabad (IN); Gopinath Dhanapal, Karnataka (IN)

(21) Appl. No.: 17/560,769

(22) Filed: Dec. 23, 2021

(51) Int. Cl. G06Q 30/00; G06F 16/25; G06N 5/02

(52) U.S. Cl. CPC G06Q 30/016; G06F 16/258; G06N 5/025; G06V 30/10

(57) ABSTRACT

An apparatus, system, method, and computer program product are provided for improved automated customer assistance based on legacy data, which may be associated with an ancestor in a family that owns a family business. Some example embodiments use legacy data not associated with the client but associated with the client's predecessor. Some example embodiments employ machine-learning modeling to facilitate automated customer assistance to generate advisories to clients that to assist the client in addressing the implementation of strategies or specific events.

### TECHNOLOGICAL FIELD

Embodiments of the present disclosure generally relate to automated customer assistance apparatuses and/or systems associated with legacy data, including providing automated customer assistance for family business management by generating advisories based on legacy data.

### BACKGROUND

Institutions provide customer assistance to clients through advisories addressing current challenges and situations faced by a client and based on current or recent client data. Advisories may assist clients by providing suggestions of solutions that the client may execute or act on. Such customer assistance, particularly automated customer assistance, however, fails to incorporate legacy data related to the client, including when the legacy data is associated with a person or entity related to the current client but housed or stored in a different system or manner than the current or recent client data. Failure to incorporate the legacy data may lead to ineffective advisories.

Existing automated customer assistance systems lack effectiveness. In particular, existing customer assistance systems fail to incorporate legacy data, and specifically are incapable of accessing, classifying, or analyzing (e.g., with effective machine learning or modeling) legacy data to generate advisories. As described herein, the Applicant has discovered problems with existing customer assistance apparatuses and systems. Through applied effort, ingenuity, and innovation, Applicant has solved many of these identified problems in the various implementations and solutions embodied in the present disclosure, which are described in detail below.

### BRIEF SUMMARY

In general, embodiments of the present disclosure provided herein provide for an automated customer service apparatus or system associated with legacy-based data. Other implementations will be, or will become, apparent to one with skill in the art upon examination of the following figures and detailed description. It is intended that all such additional implementations be included within this description be within the scope of the disclosure and be protected by the following claims.

In an example embodiment, an apparatus is provided, the apparatus comprising a processor and a memory, the memory comprising instructions that configure the apparatus to: receive, over a network, by communications circuitry, one or more legacy data objects associated with an ancestor, wherein the one or more legacy data objects use a first data format; convert legacy data in the legacy data objects to a second format; determine one or more legacy attributes associated with one or more legacy data objects; generate a first rule set based on the one or more legacy attributes; receive, from a user device over a network, a business strategy indication and a historical evaluation indication associated with the ancestor; receive one or more client data objects associated with a client, wherein the client data objects use the second data format; determine one or more suggestions based on the first rule set and the client data objects, business strategy indication, and historical evaluation indication; and generate an advisory based on the one or more suggestions.

In some example embodiments, generating the first rule set comprises: generating one or more machine learning training sets based on the legacy data; training one or more machine learning models with the one or more machine learning training sets; and generating a first rule set based on the machine learning model. In some example embodiments, the first data format is incompatible with being used in the one or more machine learning training sets. In some example embodiments, the instructions are further configured to: generate a renderable object associated with the advisory; and cause the renderable object to be displayed on a user interface of the user device. In some example embodiments, converting legacy data in the legacy data objects includes optical character recognition. In some example embodiments, the legacy data in the legacy data object is encrypted and converting legacy data includes decrypting the legacy data. In some example embodiments, the instructions are further configured to: receive, prior to determining one or more suggestions, one or more external data objects from one or more external data sources; and the determining of the one or more suggestions is further based on external data in the external data objects.

In another example embodiment, a computer program product is provided, the computer program product comprising at least one non-transitory computer-readable storage medium having computer-executable program code instructions stored therein, the computer-executable program code instructions comprising program code instructions configured to: receive, over a network, one or more legacy data objects associated with an ancestor, wherein the one or more legacy data objects use a first data format; convert legacy data in the legacy data objects to a second format; determine one or more legacy attributes associated with one or more legacy data objects; generate a first rule set based on the one or more legacy attributes; receive, from a user device over a network, a business strategy indication and a historical evaluation indication associated with the ancestor; receive one or more client data objects associated with a client, wherein the client data objects use the second data format; determine one or more suggestions based on the first rule set and the client data objects, business strategy indication, and historical evaluation indication; and generate an advisory based on the one or more suggestions.

In another example embodiment, a method is provided, the method comprising: receiving, over a network, one or more legacy data objects associated with an ancestor, wherein the one or more legacy data objects use a first data format; convert legacy data in the legacy data objects to a second format; determining one or more legacy attributes associated with one or more legacy data objects; generating a first rule set based on the one or more legacy attributes; receiving, from a user device over a network, a business strategy indication and a historical evaluation indication associated with the ancestor; receiving one or more client data objects associated with a client, wherein the client data objects use the second data format; determining one or more suggestions based on the first rule set and the client data objects, business strategy indication, and historical evaluation indication; and generating an advisory based on the one or more suggestions.

In an example embodiment, an apparatus is provided, the apparatus comprising a processor and a memory, the memory comprising instructions that configure the apparatus to: receive, over a network, one or more legacy data objects associated with an ancestor, wherein the one or more legacy data objects use a first data format; receive one or more client data objects associated with a client, wherein the one or more client data objects use the second data format; convert legacy data in the legacy data objects to a second format; determine one or more attributes associated with the one or more legacy data objects and the one or more client data objects; receive, from an external data source over a network, one or more external data objects associated with a descendant; generate a first model based on the one or more one or more attributes, the one or more legacy data objects, and the one or more external data objects; and generate an advisory based on the first model, wherein the advisory is a knowledge will.

In some example embodiments, generating the first model comprises: generating one or more machine learning training sets based on the one or more legacy data objects and the one or more client data objects; training one or more machine learning models with the one or more machine learning training sets; and generating a first model based on the machine learning model. In some example embodiments, the first data format is incompatible with being used in the one or more machine learning training sets. In some example embodiments, the instructions are further configured to: generate a renderable object associated with the advisory; and cause the renderable object to be displayed on a user interface of the user device. In some example embodiments, converting legacy data in the legacy data objects includes optical character recognition. In some example embodiments, the legacy data in the legacy data object is encrypted and converting legacy data includes decrypting the legacy data. In some example embodiments, the instructions are further configured to: receive, prior to determining one or more suggestions, one or more external data objects from one or more external data sources; and the determining of the one or more suggestions is further based on external data in the external data objects. In some example embodiments, the one or more external data objects associated with a descendant comprise descendant data associated with the business capacity of the descendant.

### BRIEF DESCRIPTION OF THE DRAWINGS

Having described various embodiments of the disclosure in general terms, reference is now made to the accompanying drawings, which are not necessarily drawn to scale.

FIG. 1 illustrates an exemplary overview of a system that can be used to practice embodiments of the present invention.

FIG. 2 illustrates an exemplary automated customer assistance system in accordance with some embodiments discussed herein.

FIG. 3 illustrates an exemplary user device in accordance with some embodiments discussed herein.

FIG. 4 illustrates a flowchart depicting example operations of a process for generating an advisory in accordance with at least some example embodiments of the present disclosure.

FIG. 5 illustrates a flowchart depicting example operations of a process for generating an advisory of a knowledge will in accordance with at least some example embodiments of the present disclosure.

### DETAILED DESCRIPTION

Embodiments of the present disclosure will be described more fully with reference to the accompanying drawings, in which some, but not all, embodiments of the disclosure are illustrated. Indeed, embodiments of the disclosure may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally,” “substantially,” and “approximately” refer to within engineering and/or manufacturing tolerances and/or within user measurement capabilities, unless otherwise indicated. Like reference numbers in the drawings refer to like elements throughout.

Many modifications and other embodiments of the disclosure set forth herein will come to mind to one skilled in the art to which this disclosure pertains after having the benefit of the teachings presented in the foregoing description and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims.

### Definitions

Although specific terms are employed herein, they are used in a generic and descriptive sense only and not for purposes of limitation.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

As used herein, the phrases “in one embodiment,” “according to one embodiment,” “in some embodiments,” “in various embodiments,” and the like generally refer to the fact that the particular feature, structure, or characteristic following the phrase may be included in at least one embodiment of the present disclosure. Thus, the particular feature, structure, or characteristic may be included in more than one embodiment of the present disclosure such that these phrases do not necessarily refer to the same embodiment.

As used herein, the word “example” is used herein to mean “serving as an example, instance, or illustration.” Any implementation described herein as “example” is not necessarily to be construed as preferred or advantageous over other implementations.

As used herein, the term “computer-readable medium” refers to non-transitory storage hardware, non-transitory storage device or non-transitory computer system memory that may be accessed by a controller, a microcontroller, a computational system or a module of a computational system to encode thereon computer-executable instructions or software programs. A non-transitory “computer-readable medium” may be accessed by a computational system or a module of a computational system to retrieve and/or execute the computer-executable instructions or software programs encoded on the medium. Exemplary non-transitory computer-readable media may include, but are not limited to, one or more types of hardware memory, non-transitory tangible media (for example, one or more magnetic storage disks, one or more optical disks, one or more USB flash drives), computer system memory or random access memory (such as, DRAM, SRAM, EDO RAM), and the like.

As used herein, the terms “data,” “content,” “information,” “electronic information,” “signal,” “command,” and similar terms may be used interchangeably to refer to data capable of being transmitted, received, and/or stored in accordance with embodiments of the present disclosure. Thus, use of any such terms should not be taken to limit the spirit or scope of embodiments of the present disclosure. Further, where a first computing device is described herein to receive data from a second computing device, it will be appreciated that the data may be received directly from the second computing device or may be received indirectly via one or more intermediary computing devices, such as, for example, one or more servers, relays, routers, network access points, base stations, hosts, and/or the like, sometimes referred to herein as a “network.” Similarly, where a first computing device is described herein as sending data to a second computing device, it will be appreciated that the data may be sent directly to the second computing device or may be sent indirectly via one or more intermediary computing devices, such as, for example, one or more servers, remote servers, cloud-based servers (e.g., cloud utilities), relays, routers, network access points, base stations, hosts, and/or the like. Examples of data may include, but are not limited to, business strategies, current business information, communications (e.g., messaging communications, conversation data, email communications, etc.), legacy business information, financial information, historical business transactions (e.g., banking transactions, investments, enrolled insurances, loans, assets, liabilities, etc.), historical financial transactions, personal information (e.g., education, family, relationships, work history, experiences, locations, etc.), social media information (e.g., social media, content shared through social media, etc.), and transactional information.

As used herein, the term “data object” and/or the like refer to a structured arrangement of data and/or electronically-managed data that is generated and/or maintained by a computing device (e.g., apparatus, computing device, or system or server of the present disclosure) and may be a collection of datum associated with the computing device. As such, In various embodiments, an example data object may contain be associated with a client (e.g., client data in a client data object), an ancestor (e.g., legacy data in an legacy data object), a descendant (e.g., descendant data in a descendant data object), or an external data source, which may be by including data relating to or associated with the ancestor, descendant, or external data source. In various embodiments, data objects may contain data in one or more different formats, which may depend on the data and/or how the data was created. In various embodiments, a data object may be encrypted or access to a data object may otherwise be limited.

As used herein, the terms “user device,” “mobile device,” and the like refer to computer hardware that is configured (either physically or by the execution of software) to communicate with one or more systems, devices, and/or servers, and is configured to directly, or indirectly, transmit and receive data. Example user devices may include a smartphone, a tablet computer, a laptop computer, a wearable device (e.g., smart glasses, smart watch, or the like), and the like. Embodiments of user devices are further described herein.

As used herein, the term “circuitry” refers to hardware and also may include software for configuring the hardware. For example, although “circuitry” may include processing circuitry, storage media, network interfaces, input/output devices, and the like, other elements may provide or supplement the functionality of particular circuitry.

Having set forth a series of definitions called-upon throughout this application, an example system architecture and example apparatus is described below for implementing example embodiments and features of the present disclosure.

### Overview

As noted above, apparatuses, systems, methods, and computer program products are described herein for automated customer assistance. While many embodiments may be described as a system, it will be appreciated that such systems may also be apparatuses.

In various embodiments, an automated customer assistance system may be utilized by an institution to generate and provide advisories to clients, such as clients involved in the management of large businesses and/or family businesses. The institution may be a financial institution that may generate and provide an advisory proactively or in response to a request from a client. Advisories may be generated by analyzing client data stored by the financial institution. Generation of an advisory using client data may rely on classifications of the client data, such as with respect to one or more attributes in view of advisory guidelines associated with the financial institution and/or a particular client. In various embodiments where the clients are part of a family business, the family business may be associated not only with current or recent client data but also with records and data of how predecessors to the current client (e.g., ancestors) ran the family business. In various embodiments, a client may be associated with a business that has current and historical records, which may include how predecessors to the current client (e.g., ancestors) ran the business. While certain embodiments herein may describe a family business, such embodiments are not limiting and may apply to non-family businesses. Automated customer assistance systems utilizing only current or recent client data fail to incorporate legacy data associated with ancestors of the client and, thus, may be ineffective.

In the example with a client with a family owned business, particularly where the current client is not the founder of the family owned business, an ancestor may have encountered and overcome challenges currently presented to the client. For example, an ancestor may be an older member of the family, such as from a prior generation, that is associated with family owned business, but the ancestor may or may not be currently associated with the family owned business. Additionally, a family business may be associated with core values that are maintained over time. In various embodiments, the core values may develop into brand recognition or brand value associated with the family business. Over time the client and ancestor(s) may have similar or different stakeholders in the family business as the stakeholders and customers may also change over time, and the brand value to the stakeholders may change over time. Similarly, the client and ancestor(s) may have similar or different competitors, and the brand value in view of competitors may also change over time. How the ancestor addressed challenges, both with success and failure, may yield valuable suggestions for a current client to consider. For example, an ancestor's failures impacting growth or brand value may be important. However records from the ancestor may not be available in a manner useable by an automated customer assistance system. It will be appreciated that the current disclosure is not restricted to family owned businesses, but provides for embodiments where legacy data associated with a current client may be considered for inclusion in generation of advisories.

Data associated with the ancestor may not be available to the client due to the institution maintaining the ancestor's data having changed. Additionally or alternatively, the ancestor's data may be stored in various manners and/or formats, including but not limited to hard copies, such as printed ledgers, journals, letters, memos, purchase orders, and/or invoices. Such hard copies are not electronically accessible on their own, and even once scanned and processed (e.g., with optical character recognition (OCR)), may still lack context surrounding the data in the scanned data object of the hard copy. In various embodiments, context may be related to business strategies, business challenges, or a business environment. Thus financial institutions may fail to include legacy data related to an ancestor of the client, which may be due to how legacy data may be accessed, formatted, stored, filtered, located, or classified.

In various embodiments, to incorporate the legacy data, an automated customer service system may receive one or more legacy data object(s). In various embodiments, legacy data object(s) include legacy data, which may address legacy decisions made by ancestors, such as in decisions made in order to grow the family business in one or more similar kinds of requirements or business context a customer may be facing. The decisions and related data may be used in determining successes and failures of an ancestor in executing the family business, including risks encountered. An exemplary business context may include, but is not limited to, types of transactions entered into in view of a business environment, such as low growth periods, which may specific to one or more geographic regions (e.g., town, city, country, etc.) and/or time (e.g., peak season, low season, etc.). Additional or alternative business contexts may include customer sentiment, social sentiment, financial growth, financial stability, location importance (e.g., location of business, subdivision, product availability, etc.), values (e.g., expressly stated values, values as determined by survey of stakeholders, etc.), and/or visions (e.g., expressly stated visions, visions as determined by survey of stakeholders, etc.).

In various embodiments, a client may request an advisory or an institution may provide an advisory proactively based on a trigger. An exemplary trigger may be a time period or a threshold associated with the client data available to the automated customer service system. In various embodiments the advisory may be based on classification of transaction data as well as the application of machine learning or of a model, such as with respect to one or more attributes in view of advisory guidelines associated with the financial institution and/or a particular client.

An automated customer assistance system may generate an advisory from clients data such as transaction data and client requirements. In various embodiments, transaction data may be classified based on different attributes. In various embodiments, transaction data may include transactions associated with assets, liabilities, revenue, profit, business valuation, income to expense ratio, etc. Attributes may be included in data objects containing financial transaction data as attributes associated with the financial transaction data. The classifications may be evaluated with respect to advisory guidelines, available products, and solutions related to business management that the institution may provide. In various embodiments, solutions related to business management may include products offered by a financial institution or advise on actions the client may take.

An advisory may be directed to suggestions of actions or strategies to maintain or strengthen a business portfolio, such as by enabling business growth, including brand growth. In various embodiments, an advisory may be an electronic advisory and provided in one or more manners or formats. In various embodiments, the format of the advisory may be of a renderable data object that allows a client to respond to implement a suggestion or proposal in the advisory.

In various embodiments, a client with a family business may be challenged with addressing succession planning and request an advisory to address this challenge. This may present the client with challenges such as limited capital, lack of preparation of next-generation leadership, lack of business capacity, inflexibility and resistance to change, sibling successor conflict, disparate family goals, etc. In various embodiments, any one of these challenges may lead to closure or reduced business growth for the family business. Conventional advisory suggestions do not incorporate legacy data along with data from external sources, and the client may not be able to formulate efficient strategies. In various embodiments, by utilizing legacy data and data from external sources along with the client data, a knowledge will enable one or more owners of the family business to leverage legacy business knowledge as well as retrieve future projections of prospects for the family business.

### Example Systems and Apparatuses

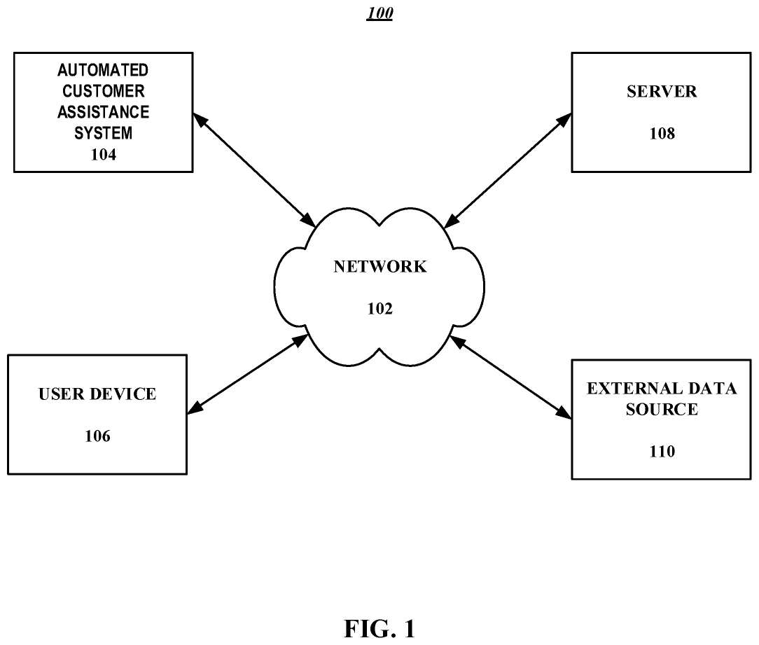

FIG. 1 illustrates an exemplary overview of a system that can be used to practice embodiments of the present invention. As illustrated in FIG. 1, an automated customer assistance system 104 is communicatively coupled with at least one user device 106, a server 108, and one or more external data sources 110 via a network 102. In various embodiments, the automated customer service system 104 may be configured as a stand-alone system. In various embodiments the automated customer service system 104 may have a server 108 integrated.

Automated customer assistance system 104 may, as further described herein, receive one or more types of data (e.g., client data, legacy data, etc.), such as in one or more data objects, and generating advisories based on the data.

User device 106 is communicatively coupled to the customers assistance system 104 via network 102 and is capable of communications with the customer assistance system 104. In various embodiments, communication by the user device 106 over the network 102 may be via an application installed on the user device 106.

In various embodiments, an application may be configured to run on a user device and may display data and/or data objects related to one or more advisories. The application may also communicate with the server 106, including to browse advisories, associated detailed explanations, and/or statistical information associated with the client and/or an ancestor. In various embodiments, such as with an advisory of a knowledge will, the application may be configured to display data received by the automated customer assistance system 104 related to knowledge will. In various embodiments, the application may also be configured for a client to design around a rule set or an analytical model generated by an evaluation engine 204.

Server 108 may be configured to store data in data objects, such as historical transaction data and communication log data (e.g., communications between the client or ancestor and an institution) for a client and/or an ancestor. The server 106 may also be configured to store data objects associated with social information data of or associated with the client or ancestor. The server 106 may communicate with external data sources 110, including but not limited to social media data sources (e.g., websites or servers). In various embodiments, communication with external data sources may be via suitable Application Programming Interfaces (APIs). In various embodiments, suitable APIs may include or be configured for encryption, format conversion, and/or timing settings (e.g., real-time, batch, scheduled, and/or triggered) associated with providing and/or receiving data and/or data objects. In various embodiments, communication with external data sources 110 may allow for retrieving different external data, such as social media information data, brand value data, business reputation data, stakeholder data, etc. associated with the client and/or ancestor. In one embodiment, the server 108 may be configured to receive or provide data or data objects by means of secured APIs, which may use one or more types of encryption.

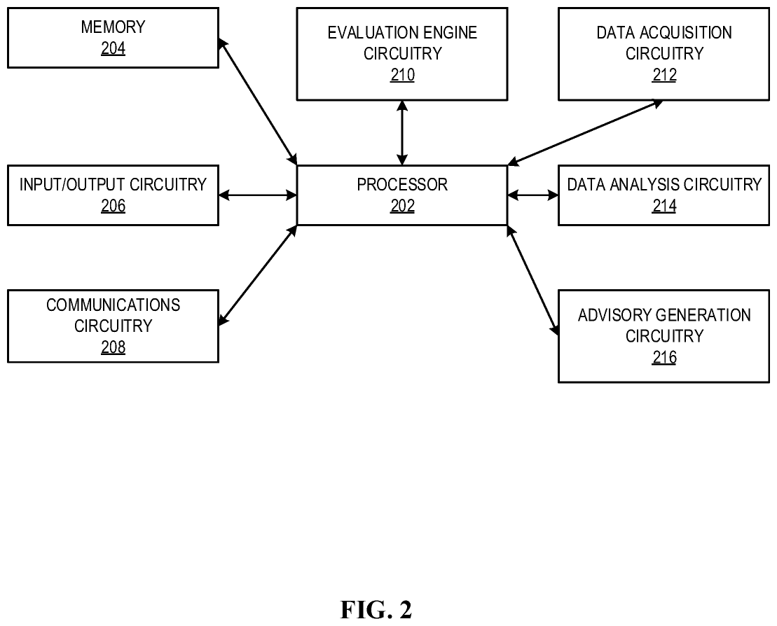

FIG. 2 provides an illustration of an exemplary automated customer assistance system 104 in accordance with various embodiments discussed herein.

The customer assistance system 104 may be embodied by one or more computing systems or devices, such as shown in FIG. 2 (e.g., an apparatus of the present disclosure). While FIG. 2 provides an exemplary automated customer assistance system 104, it will be appreciated modifications may be made to the illustrated embodiment, such as certain illustrated circuitry not being present in every embodiment described herein or additional circuitry being present.

In various embodiments, the automated customer service system 104 may include processor 202, memory 204, input/output circuitry 206, communications circuitry 208, evaluation engine circuitry 210, data acquisition circuitry 212, data analysis circuitry 214, and/or advisory generation circuitry 218. The automated customer service system 104 may be configured to execute the operations described herein. Although these components 202-218 are described with respect to functional limitations, it should be understood that the particular implementations necessarily include the use of particular hardware. It should also be understood that certain of these components 202-218 may include similar or common hardware. For example, two sets of circuitries may both leverage use of the same processor, network interface, storage medium, or the like to perform their associated functions, such that duplicate hardware is not required for each set of circuitries. It should also be understood that while FIG. 2 illustrates connectors between components 204-216 and processor 202, the components may be directly connected to each other.

The processor 202 may be embodied in a number of different ways and may, for example, include one or more processing devices configured to perform independently. In some embodiments, the processor 202 may include one or more processors configured in tandem via a bus to enable independent execution of instructions, pipelining, and/or multithreading. In various embodiments, the processor 202 may include a single core processor, a multi-core processor, multiple processors internal to the apparatus, and/or remote or “cloud” processors.

In various embodiments, the processor 202 may be configured to execute instructions stored in the memory 204 or otherwise accessible to the processor 202. In various embodiments, the processor 202 may be configured to execute hard-coded functionalities. As such, whether configured by hardware or software methods, or by a combination thereof, the processor 202 may represent an entity (e.g., physically embodied in circuitry) capable of performing operations according to an embodiment of the present disclosure while configured accordingly. Alternatively, as another example, when the processor 202 is embodied as an executor of software instructions, the instructions may specifically configure the processor 202 to perform the algorithms and/or operations described herein when the instructions are executed.

In various embodiments, the processor 202 (and/or co-processor or any other processing circuitry assisting or otherwise associated with the processor) may be in communication with the memory 204 via a bus for passing information among components of the system or apparatus. The memory 204 is non-transitory and may include, for example, one or more volatile and/or non-volatile memories. In other words, for example, the memory 204 may be an electronic storage device (e.g., a computer-readable storage medium). The memory 204 may be configured to store data objects, data, content, applications, instructions, or the like for enabling the system or apparatus to carry out various functions in accordance with embodiments of the present disclosure.

In various embodiments, the automated customer service system 104 may include input/output circuitry 206 that may, in turn, be in communication with processor 202 to provide output to a user and to receive an indication of a user's input. The input/output circuitry 206 may comprise a user interface (e.g., one or more input devices and a display), a web user interface, a mobile application, a query-initiating computing device, a kiosk, or the like. In various embodiments, the input/output circuitry 206 may include a keyboard, a mouse, a joystick, a touch screen, touch areas, soft keys, a microphone, a speaker, or other input/output mechanisms. The processor 202 and/or user interface of the input/output circuitry 206 may be configured to control one or more functions of one or more user interface elements through computer program instructions (e.g., software and/or firmware) stored on a memory accessible to the processor (e.g., memory 204, and/or the like).

The communications circuitry 208 may be any means such as a system, device, and/or circuitry embodied in either hardware or a combination of hardware and software that is configured to receive and/or transmit data from/to a network and/or any other device, circuitry, or module in communication with the automated customer service system 200. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally or alternatively, the communications circuitry 208 may include circuitry for interacting with the antenna/antennae to cause transmission of signals via the antenna/antennae or to handle receipt of signals received via the antenna/antennae. These signals may be transmitted by the automated customer service system 200 using any of a number of wireless personal area network (PAN) technologies, such as Bluetooth® v1.0 through v3.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols.

The evaluation engine circuitry 210 may comprise hardware components configured to evaluate data (e.g., legacy data, client data, external data, descendant data, etc.) using, in various embodiments, machine learning. The evaluation engine circuitry 210 may execute one or more machine learning models, described in further detail herein, one or more natural language processing (NLP) algorithms, and/or communication with one or more databases, which may store one or more training sets for use with a machine learning model (e.g., a first training set, a second training set, a third training set, an N^{th} training set). The evaluation engine circuitry 210 may utilize processing circuitry, such as the processor 202, to perform its corresponding operations and may utilize memory 204 to store collected information.

The evaluation engine is configured identify and/or determine a rule set, business context, risks, brand value, business aspects, attributes, decision making parameters, and/or patterns based on the data analyzed (e.g., legacy data, client data, external data, etc.). In various embodiments, the evaluation engine may determine a computational model. The evaluation engine may make its determinations with machine learning, which may include a machine learning model trained based on one or more data sets of data (e.g., legacy data, client data, external data, etc.).

In various embodiments, a business context and one or more decision making parameters relate to a transaction or to a client's business. The evaluation engine circuitry 210 may also determine attributes based on the identified business context and decision making parameters, where the attributes may be indicative of a business style of an ancestor. The evaluation engine may also identify patterns, including one or more business practices, failures, successes, year-over-year growth, year-over-year losses, repeating year-over-year patterns, early payments (e.g., by the client and/or stakeholders), payment delays (e.g., by the client and/or stakeholders), etc. In various embodiments, the identification of patterns may also include one or more surveys to one or more clients (described herein) to determine or assist in the determination of patterns and/or subparts of a pattern, including but not limited to financial transaction analysis, trigger points, thresholds, margins, etc. In various embodiments, a pattern of low points, high points, and margins may be determined and a client may provide feedback data from a survey of such a pattern of trigger points. On receiving client feedback data, the automated customer assistance system 104 may incorporate the feedback, which may be stored as client data, and may reiterate the identification of patterns. In various embodiments, client feedback data may indicate for the automated customer assistance system 104 to consider additional data (e.g., legacy data, client data, etc.), and such indication may cause the automated customer assistance system 104 to create one or more surveys.

In an exemplary embodiment, a pattern may be identified indicating a successful year as defined by the client (e.g., target amount of growth realized, defined as successful in client feedback data, etc.), the pattern may be displayed to a client in a survey, and the client may provide feedback data by adjusting one or more thresholds, adjusting one or more trigger points, and indicating the system to consider additional data (e.g., legacy data, client data, etc.), such as stakeholders who delayed in payment and stakeholders who paid early. The automated customers assistance system 104 may iterate and develop one or more additional patterns, including payment timing. In an embodiment where stakeholder payment data may not be available, one or more surveys may be transmitted to one or more clients to input or to estimate payment data (e.g., timing, payment type (e.g., cash, check, third party credit), etc.) to the system, which may include inputs or estimates for each trigger point in the pattern (e.g., time of year, amount outstanding, extra time given to pay, forgiveness, etc.).

In various embodiments, the rule set may be based on analysis of transactional patterns, financial insights, business strategies, strategy outcome, successful business deals, failed business deals etc., which may be associated with the client, ancestor, or competitors. The evaluation engine may also be configured with complex numerical techniques to determine the rule sets.

In various embodiments, business aspects may include risks, strategy failure patterns, brand value, market review of client, financial risk, etc. In various embodiments, risks may include stakeholder risk, operational risk, financial risk etc.

In various embodiments, attributes may include, but are not limited to, stakeholder relationship, risk associated with stake holders, strategy failure pattern, brand value, market review, average turn over, revenue, liabilities, expenditure etc. Additionally, the attributes may be expressed in statistical representations of the attribute.

In various embodiments, the machine learning module determines one or more rule sets based on one or more of the attributes. Additionally, the machine learning module may determine a business style, which may include different transactional contexts, financial insights, business strategies, reinvestment decisions, changes in stakeholders, change in employees, asset sales, taking loans, growing business, shrinking business, etc.

In various embodiments, the evaluation engine circuitry 210 may determine a computational model based on data (e.g., legacy data, client data, external data, etc.). The computational model may be expressed in statistical representation and may be operated via an application on a user device 106. In various embodiments, a computation model may be based on risks and brand value. In various embodiments, the machine learning model may determine different business aspects and then determine a computational model based on the business aspects.

The data acquisition circuitry 212 may comprise hardware components configured to acquire and receive data (e.g., legacy data, client data, external data), which may be received as data objects. In various embodiments, the data acquisition circuitry 212 may generate requests to retrieve data by using the communications circuitry 208 to communicate with, for example, user devices 106, server 108, and/or external data sources 110. The data acquisition circuitry 212 may utilize processing circuitry, such as the processor 202, to perform its corresponding operations, and may utilize memory 204 to store collected information. In various embodiments, the data acquisition circuitry 212 may transmit data to the data analysis circuitry 214 for further processing. In various embodiments, the data acquisition circuitry 212 may receive an advisory request from a client via a user device 106. The data acquisition circuitry 212 may simultaneously generate requests to retrieve legacy data, client data, and/or external data in response to the advisory request.

The data analysis circuitry 214 may comprise hardware components configured to analyze data (e.g., legacy data, client data, external data). The data analysis circuitry 214 may utilize processing circuitry, such as the processor 202 as well as the evaluation engine circuitry 210, to perform its corresponding operations, and may utilize memory 204 to store collected information. In various embodiments, the data acquisition analysis circuitry 214 may receive data and data objects transmitted by data acquisition circuitry 212.

In various embodiments, the data analysis circuitry 214 may make identifications and/or determinations in conjunction with the evaluation engine circuitry 210. In various embodiments, the data analysis circuitry 214 may store what has been identified and determined by the evaluation engine circuitry 210, such as business context, the decision making parameters, attributes, and patterns.

Based on the determined attributes, the data analysis circuitry 214 may determine a rule set. The rule set may be statistical representation of the underlying data (e.g., client data, legacy data, external data, etc.). The determined attributes, in view of the rule set, may indicate successful and unsuccessful business decisions of an ancestor.

In an example, the data analysis circuitry 214 in conjunction with the evaluation engine circuitry 214 analyzes the legacy data, brand value, and risk to generates a computational model, which may include one or more of the attributes. The computational model may represent a variety of statistical information.

The advisory generation circuitry 216 may comprise hardware components configured to generate an advisory, which in some embodiments may be a knowledge will. The advisory generation circuitry 216 may utilize processing circuitry, such as the processor 202, to perform its corresponding operations, and may utilize memory 204 to store collected information.

In various embodiments, the advisory generation circuitry 216 receives a business context from the data analysis circuitry 216 and apply a rule set to generate an advisory, which may include suggestions. The advisory generation circuitry 216 may determine one or more rule sets from a plurality of rule sets and may generate a set of suggestions and detailed explanation of such suggestions. In various embodiments, the detailed explanation of the suggestions includes business context of an ancestor, different statistical information related to the suggestions, positive or negative impact of such suggestions, etc. In various embodiments, the advisory generation circuitry 216 may provide the suggestions and explanations to a user device and enables the client to browse through each of the suggestions and explanations.

In various embodiments, the advisory generation circuitry 216 may generate an advisory of a knowledge will. The advisory generation circuitry 216 receives data (e.g., legacy data, client data, external data, etc.), which may include client data input via an application on a user device 106. In various embodiments, if the client does not identify one or more descendants, the advisory generation circuitry 216 may identify or determine one or more descendants of the client, which may be owner of the family business, by analyzing personal information. The advisory generation circuitry 216 may also determine the business capacity of each of the identified descendants. In various embodiments, business capacity may include business intelligence and/or financial capacity, which may be based on personal profile and financial information, including education, press releases, announcements, social media posts, experience in one or more relevant fields or lack thereof. Additionally or alternatively, intelligence and/or financial capacity may be identified in or determined from legacy data, client data, or external data, such as announcements or social media posts, such as those stating goals, ambitions, location preferences, demonstrations of leadership, execution of strategy. In various embodiments where the one or more descendants may be engaged with the client's business, client data associated with the descendant(s) may be identified, determined, and/or used. The advisory generation circuitry 216 dynamically generate a knowledge will, which may include suggestions regarding future business strategies based on the analytical model and business capacity of the descendants. In various embodiments, an advisory of a knowledge will may enable a client to apply legacy data to determine future prospects of the client's business.

It should also be appreciated that, in some embodiments, the evaluation engine circuitry 210, data acquisition circuitry 212, data analysis circuitry 214, and/or advisory generation circuitry 218 may include a separate processor, specially configured field programmable gate array (FPGA), or application specific interface circuit (ASIC) to perform its corresponding functions. In addition, computer program instructions and/or other type of code may be loaded onto a computer, processor or other programmable wire transfer validation server's circuitry to produce a machine, such that the computer, processor other programmable circuitry that execute the code on the machine create the means for implementing the various functions, including those described in connection with the components of automated customer service system 200.

As described herein and as will be appreciated, embodiments of the present disclosure may be configured as systems, apparatus, mobile devices, methods, and the like. Accordingly, embodiments may comprise various means including entirely of hardware or any combination of software with hardware. Furthermore, embodiments may take the form of a computer program product comprising instructions stored on at least one non-transitory computer-readable storage medium (e.g., computer software stored on a hardware device). Any suitable computer-readable storage medium may be utilized including non-transitory hard disks, CD-ROMs, flash memory, optical storage devices, or magnetic storage devices.

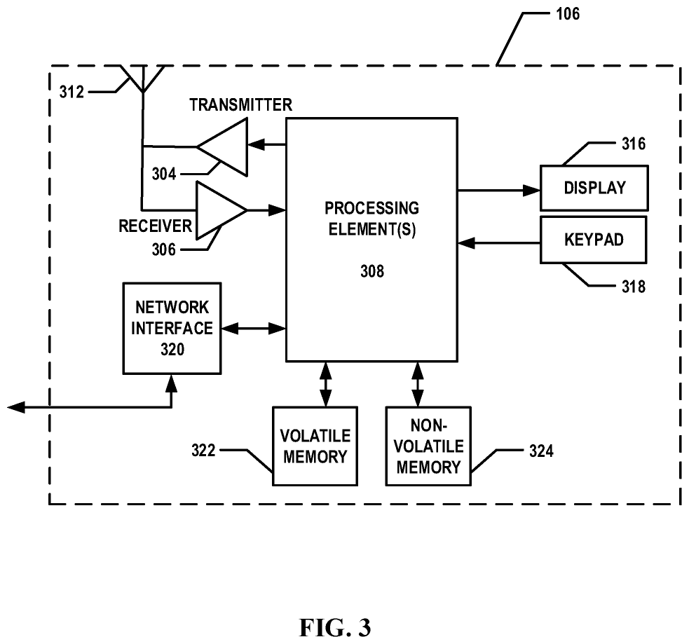

FIG. 3 provides an exemplary user device in accordance with some embodiments discussed herein. In various embodiments, a user device 106 is a classical (e.g., semiconductor-based) computer configured to allow a user to provide input (e.g., via a user interface of the user device 10) and receive, display, analyze, and/or the like output from the customer assistance system 104. In various embodiments, a user may use user device 106 to provide input to the customer assistance system 104, such as when a user may provide input that results in a process on the customer assistance system 104 executed.

As shown in FIG. 3, a user device 106 can include an antenna 312, a transmitter 304 (e.g., radio), a receiver 306 (e.g., radio), and a processing element 308 that provides signals to and receives signals from the transmitter 304 and receiver 306, respectively. The signals provided to and received from the transmitter 304 and the receiver 306, respectively, may include signaling information/data in accordance with an air interface standard of applicable wireless systems to communicate with various entities, such as a customer assistance system 104, other user devices 106, server 108, external data sources 110, and/or the like. The user device 106 can include a network interface 320, which may provide signals to and receive signals in accordance with an interface standard of applicable network systems to communicate with various entities, such as a customer assistance system 104, other user devices 106, server 108, external data sources 110, and/or the like.

In this regard, the user device 106 may be capable of operating with one or more air interface standards, communication protocols, modulation types, and access types. For example, the user device 106 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the user device 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra wideband (UWB), infrared (IR) protocols, near field communication (NFC) protocols, Wibree, Bluetooth protocols, wireless universal serial bus (USB) protocols, and/or any other wireless protocol. The user device 106 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via such communication standards and protocols, the user device 106 may communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The user device 106 may also download changes, add-ons, and updates, for instance, to its firmware, software (e.g., including executable instructions, applications, program modules), and operating system.

The user device 106 may also comprise a user interface device comprising one or more user input/output interfaces (e.g., a display 316 and/or speaker/speaker driver coupled to a processing element 308 and a touch screen, keyboard, mouse, and/or microphone coupled to a processing element 308). For instance, the user output interface may be configured to provide an application, browser, user interface, interface, dashboard, screen, webpage, page, and/or similar words used herein interchangeably executing on and/or accessible via the user device 106 to cause display or audible presentation of information/data and for interaction therewith via one or more user input interfaces. The user input interface can comprise any of a number of devices allowing the user device 106 to receive data, such as a keypad 318 (hard or soft), a touch display, voice/speech or motion interfaces, scanners, readers, or other input device. In embodiments including a keypad 318, the keypad 318 can include (or cause display of) the conventional numeric (0-9) and related keys (#, *), and other keys used for operating the user device 106 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the user device 106 can collect information/data, user interaction/input, and/or the like.

The user device 106 can also include volatile storage or memory 322 and/or non-volatile storage or memory 324, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the user device 106.

### Example Advisory Processes

Having described example systems, apparatuses, computing environments, and data visualizations of the disclosure, example processes in accordance with the present disclosure will now be described. It will be appreciated that each of the flowcharts depicts an example computer-implemented process that may be performed by one or more of the apparatuses, systems, devices, and/or computer program products described herein, for example utilizing one or more of the specially configured components thereof.

The blocks depicted in the flowcharts indicate operations. Such operations may be executed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process, such as being repeated to perform the block in one or more iterations. Additionally or alternatively, any of the processes may include some or all operational steps described and/or depicted, including one or more optional blocks in some embodiments. With regard to the flowcharts illustrated herein, one or more of the depicted blocks may be optional in some, or all, embodiments of the disclosure. Similarly, it should be appreciated that one or more of the operations of each flowchart may be combinable, replaceable, and/or otherwise altered as described herein.

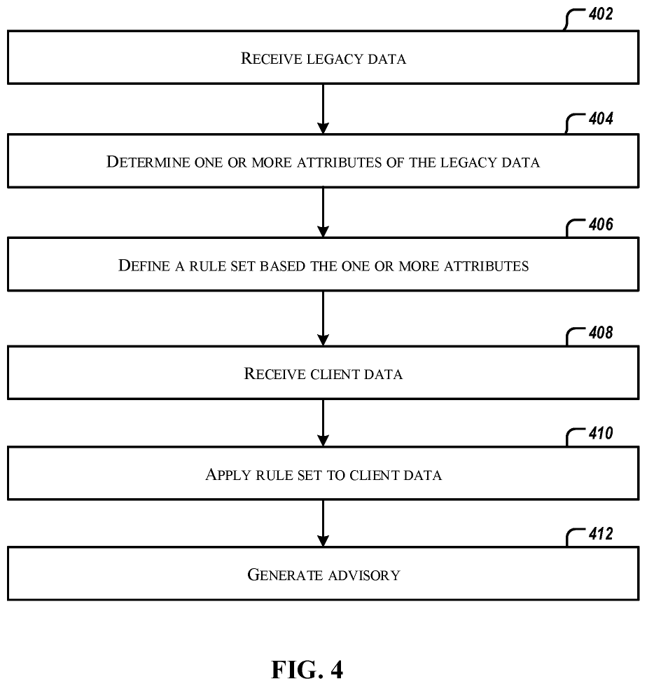

FIG. 4 illustrates a flowchart depicting example operations of a process 400 for generating an advisory in accordance with at least some example embodiments of the present disclosure.

At operation 402 of FIG. 4, the automated customer assistance system 104 receives legacy data. The legacy data may be associated with an ancestor. In various embodiments, the legacy data received may be in one or more data objects. The data in the data objects may include data associated with an ancestor, including but not limited to historical financial information data, historical transaction data, business strategy data, business reputation data, social information data, and/or personal information data. In various embodiments, the legacy data received may be from user devices 106 associated with an ancestor, servers 108, and/or external data sources 110.

In various embodiments, after receiving legacy data objects the legacy data and/or the legacy data objects may be converted to a new format. In various embodiments, legacy data may be received from an ancestor or an institution associated with the ancestor, and the legacy data and/or the legacy data object may be kept in a format associated with the ancestor or the ancestor's institution. In various embodiments, this format may not be used by the automated customer assistance system 104. In one example, the legacy data may include scans of a hard copy document but such a scan may not be used as received. The automated customer assistance system 104 may convert the hard copy to another format, such as with the use of optical character recognition to convert the hard copy to another data format. In one example, the other data format may reflect the information in the hard copy but be a separate text file. Alternatively or additionally, the format may be such that any use of it by the automated customer assistance system 104 may be inefficient. In one example, the automated customer assistance system 104 may store numbers as text, which may cause the automated customer assistance system 104 to operate inefficiently if needing to process the legacy data in its original format. In various embodiments, the legacy data and/or legacy data object may be converted from the format it is received in to a different data format used by the automated customers assistance system 104.

In various embodiments, the format of the legacy data object received may be of an older format that may or may not be supported by the automated customer assistance system 104. In one example, the format of a legacy data object may be in an older Microsoft Excel format (e.g., .xls) may be converted to a current or modern format (e.g., .xlsx). In various embodiments, older data object formats may not include features utilized by the current data object formats, which may cause the automated customer assistance system 104 to generate errors, execute inefficiently, or fail to execute. In various embodiments, conversions may be, or may include, normalizing data to a preferred format. During normalizing a value and/or an attribute may be compared to corresponding preferred value(s), configuration(s), or rule(s), and an action may be taken to use the preference. Normalization may also be rules based, such as normalizing to a preferred values or rule(s); normalizing an entire data object (e.g., converted document) at one time based on a preferred values or rule(s); normalizing values in real-time as a data object is converted; and/or normalizing relationships between values, data, and/or data objects. Such normalization may improve quality and consistency.

In various embodiments, the legacy data and/or legacy data objects may be filtered. In various embodiment, the filtering may generate a new legacy data object that omits legacy data in the old legacy data object that may not be needed by the automated customer assistance system 104. Additionally or alternatively, the filtering may classify the legacy data, which may include an indication of legacy data that may be deleted or omitted in generating the new legacy data object. In various embodiments, the reduction in size of a legacy data object may improve the execution speed of the automated customer assistance system 104, including in transmitting, processing, and accessing the legacy data object and/or also in developing machine learning model training sets and execution of machine learning.

In various embodiments, classification of legacy data, such as during conversion and/or filtering or as a byproduct of conversion and/or filtering, may include adding metadata, tags, flags, or indicators to the data objects, each of which may be associated with one or more of the data. In an example, each of the conversion process and the filtering process may add metadata and flags to indicate that the legacy data was converted and filtered and the type of conversion and filtering that occurred along with the time it occurred. Additionally or alternatively, tags and/or indicators may be added to the legacy data and/or a legacy data object containing the legacy data to tag or indicate the results of the conversion or the filtering. For example, during a process that involves multiple filters, the filter type, value, and order may be added with metadata and/or tags and the final filtered results may be associated with indicators.

The addition of metadata, tags, flags, or indicators improve the speed and effectiveness of filtering the data. In various embodiments, the classifications of data may be used in generation of training data for a machine learning model. In various embodiments, the classifications may be used to generate new data objects that may contain one or more of the classifications. In an example, a scan of a hard copy document may be received, optical character recognition of the scan may be performed to generate an associated text data object associated with the scan, and the data in the text data object may be classified according to what type of data is in the text data object. In an example of an invoice being scanned, the classifications may add who sent the invoice, their address, the invoice's date, the amount of the invoice, and the individual line items in the invoice.

In various embodiments, the an original data object received may be too large to process or to process efficiently and the automated customer assistance system 104 may be parsed create a new data object with the classifications associated with the data in the data object so that the new data object may be used by the automated customer assistance system 104 instead of the original data object. In various embodiments, the data in the new data object may be pointers to or indicators of data in the original data object. In various embodiments, the automated customer assistance system 104 may use the new data object to identify portions of the original data object.

At operation 404 of FIG. 4, the automated customer assistance system 104 determines one or more attributes of the legacy data (e.g., legacy attributes). The automated customer assistance system 104 may determine the one or more attributes using the evaluation engine circuitry 210.

In various embodiments, the attributes may include an ancestor's business style, traditional business knowledge, stakeholder identity, type of stakeholders, stakeholder relationships, stakeholder risks, strategy failure pattern, risk appetite, investment pattern, transaction style, payment habit, context of transactions, situational business strategies, failure patterns, brand value of the family business, market review of the family business, average turn over, revenue, liabilities, expenditures, etc.

In various embodiments, the one or more attributes may be determined by using a machine learning model. The machine learning model may be trained by one or more training data sets, which may be created from the legacy data in legacy data objects associated with an ancestor. Additionally or alternatively, some or all the legacy data may be associated with classifications received from a client that, for example, classifies a context, transaction type, strategy, or pattern as determined by the client. In various embodiments, a client classification may provide context for the machine learning model, which may allow the machine learning model to determine attributes that address a client's specific situation or event. The machine learning model may use the data in one or more data objects to train to the machine learning model. In various embodiments, such data objects may be identified by the client for use and/or identified by the automated customer assistance system 104 for use.

The automated customer assistance system 104 may store the determined attributes along with business context and decision-making parameters. In various embodiments, a data objects containing the determined attributes may include data (e.g., points, indicators, flags, etc.) associating the determined attributes with other data objects containing data regarding the business text and/or decision-making parameters.

At operation 406 of FIG. 4, the automated customer assistance system 104 defines one or more rule sets based on the analysis of the determined attributes. In various embodiments, the rule sets may be analytical rules The automated customer assistance system 104 may define the rule sets using the evaluation engine circuitry 210.

The automated customer assistance system 104 defines or determines a rule set with respect to the determined attributes. In various embodiments, the set of rule set may address a specific situation, such as the rule set addressing one or more actions to implement a strategy in an environment faced by the client to yield a result. In various embodiments, machine learning models may be used to define or determine the rule set, which may be run one time, continuously, or at specific periods of time (e.g., monthly), with each subsequent machine learning model incorporating recent data, which the automated customer assistance system 104 may check for and, if determined to be necessary, update training sets with. In various embodiments, the rule set may be based on attributes including statistically representable data. The rule set defined or determined may be in the form of a model that may be applied to one or more attributes. In various embodiments, the rule set may be used with one or more attributes to determine if a business decision was successful or unsuccessful.

In an example, the rule set may include an action of a percentage to invest (e.g., 5% of monthly revenue) to implement a strategy of business expansion during an environment of a low economic growth, which may be based on an ancestor having faced a similar environment and achieved a result of producing a surplus revenue (e.g., $20,000). In a second example, a rule set may include an action in response to one or more trigger points and/or one or more thresholds wherein the triggers points and/or thresholds are associated with a historic action associated with leading to or resulting from the historic action.

At operation 408 of FIG. 4, the automated customer assistance system 104 receives client data. In various embodiments, the client data includes financial information data, transactional data, and client business strategy data. In various embodiments, the client data received may be in one or more data objects. The client data in the data objects may include data associated with the client, including but not limited to financial information data, transaction data, business strategy data, business reputation data, social information data, and/or personal information data. In various embodiments, the client data received may be from user devices 106 associated with a client, servers 108, and/or external data sources 110.

In various embodiments with the client data received from a user device 106, a client may enter the data on an input of the user device 106. The client may be prompted as to what to input. In various embodiments, the prompts may be from an application running on an API. In various embodiments the client may provide client data via a response to a survey generated by the automated customer assistance system 104 and provided to the client, such as via a network 102 to a user device 106. In completing a survey, the client may provide data and/or one or more indications as to, for example, a business strategy or challenge. Additionally or alternatively, a survey may be used to receive a historical evaluation indication from a client evaluating one or more data of the legacy data regarding an ancestor, such as if legacy data reflects successes or failures. In various embodiments, the client data and/or indications may trigger one or more advisories to be generated once received, which may cause process 400 to iterate.

In various embodiments, the client data may be kept in one or more data objects, and the client data objects may be kept in the automated customer assistance system 104, in a user device 106, in a server 108, or in an external data source 110. In various embodiments, receiving client data may include an identification of one or more ancestors, which may be used to request legacy data associated with an ancestor from one or more sources, such as a user device 106 associated with the ancestor, a server storing legacy data, and/or an external data source 110. The identification of ancestors may cause process 400 to iterate through operations that previously occurred (e.g., operations 402, 404, or 406).

At operation 410 of FIG. 4, the automated customer assistance system 104 applies the rule set from operation 406 to the client data received in operation 408. In various embodiments, the automated customer assistance system 104 dynamically analyzes the client data with respect to the rule set. In various embodiments analyzing the client data with respect to a rule set may include determining if one or more trigger points and/or one or more thresholds have been reached. In various embodiments, the automated customer assistance system 104 determines the business context and the client's business style based on the legacy data and the client data. In various embodiments, the application of the analytical rules may predict one or more suggestions along with respective explanations from the ancestor's business style of similar context of the customer's business situation. In various embodiments, application of the analytical rule set may include comparative analysis of business style of the client. In various advisories, suggestions from the ancestors' business management policies for similar context of the customer's business strategies and provides the determined suggestions to the customer to aid in more efficient decision making in terms of maintaining the family business.

At operation 412 of FIG. 4, the automated customer assistance system 104 generates an advisory. In various embodiments, an advisory may be a data object that is renderable on a user interface, such as the display 316 of user device 106. In various embodiments, the advisory may include suggestions related to the family business based on the analysis and provide generated suggestions to the customer. The advisory generated may be in a suitable format for the interface of the user device of the customer and enables the customer to browse through the details of each of the suggestions and explanations.

In various embodiments, the generation of an advisory may use machine learning models to identify and provide a suggestion along with a detailed explanation of the suggestion. In various embodiments, the suggestion may be an alternative to a current action or set of actions a client is undertaking. Alternatively, or additionally, in various embodiments a suggestion may be all or a subset of actions taken by one or more ancestors. In various embodiments, such models may include banking models, which may provide information to include in the detailed explanation. The detailed explanation may include statistical information associated with the suggestion along with business context of both the client and the ancestor from which the legacy data is associated with.

In an example embodiment, an automated customer assistance system 104 may generate an advisory on the brand value of a family business. A family business may have been operating for generations, and the brand value may be a significant source of its value to customers. The brand value may be established by one or more ancestors and be continued by current clients. The ancestors, in administering the family business, may have encountered situations and business environments similar to those faced by the current client, though the records associated with the ancestors may be kept in a variety of formats, such as hard copies. An advisory may be generated by first receiving legacy data of the ancestor's activity. This may include scanning hard copies to create legacy data, performing optical character recognition on the legacy data, classifying the legacy data, and/or filtering the legacy data. One or more attributes of the legacy data may be determined that are related to the brand value of the family business. Based on the attributes determined, a rule set may be created using machine learning that may be applied to the current client data to assist the current client with addressing issues with brand value, such as maintaining or improving brand value in view of the client's business strategy or business environment. The client may provide, and the automated customer assistance system may receive, client data a business strategy indication that provides a business strategy the client may be considering, such as growth of financial metrics or growth of the family business in a new area, such as a new geography or a new product. The rule set may include statistical model that may be applied to client data. Client data may be received, which may include financial data, transactional data, and business strategies. The rule set is applied to the client data to generate suggestions related to the brand value of the family business. The suggestions are prepared in an advisory that is transmitted to the client, and the client may review the advisory on a user device 106. The advisory includes suggestions as well as explanations related to the suggestions for how the client may maintain or grow the brand value in view of the business strategy provided by the client.

In various embodiments, the advisory may be transmitted to one or more user devices 106. In various embodiments with more than one owner of the family business, the advisory may be transmitted to a user device 106 of each owner. For each recipient of an advisory, the automated customer assistance system 104 may format the advisory data object for display on each of the user devices 106. In various embodiments, the format may include changing the size of how data is displayed along with the format of displays. For example, some information in advisory may be omitted, such as figures or detailed summaries of suggestions. The advisory data object may include all of the possible actions determined, and all or a subset of the possible actions may be presented to a client on a user device 106. In various embodiments, the actions presented may be limited by the authority or position of the user associated with a user device 106 such that only actions that may be taken by that client are presented. This may be accomplished by the automated customers assistance system 104 determining an authority level of a client and filtering suggestions based on the authority level. Once presented on a display of user device 106, a client may review the suggestions and any detailed explanations and take action as appropriate, which in various embodiments may include providing feedback data to the automated customer assistance system 104 to incorporate into the advisory.

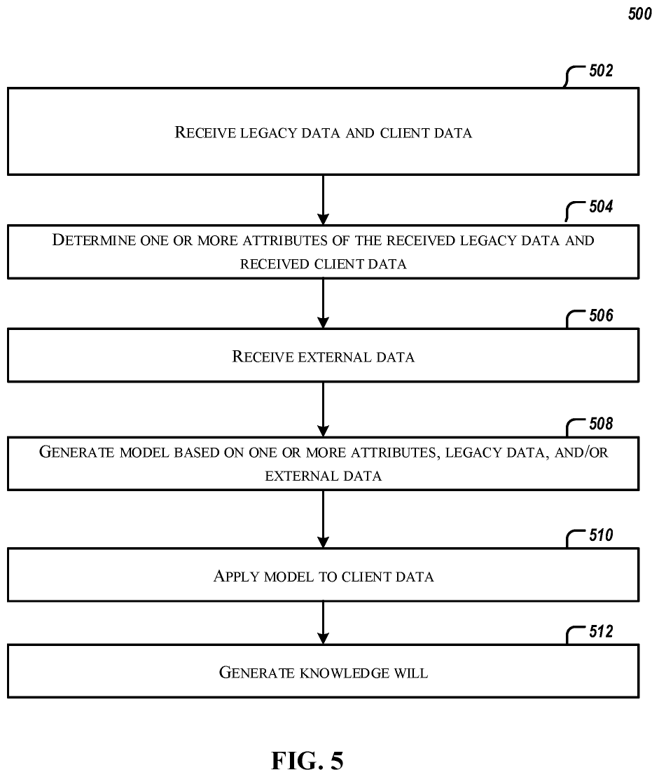

FIG. 5 illustrates operations of an example process 500 for generating an advisory of a knowledge will using an automated customer assistance system 104 in accordance with at least some example embodiments of the present disclosure.

At operation 502 of FIG. 5, the automated customer assistance system 104 receives legacy data and client data. The receiving of legacy data and client data are described above, such as by receiving one or more data objects over a network from, for example, a user device 106, a server 108, and/or an external data source 110.

In various embodiments, and as discussed above, the legacy data and/or legacy data object may be converted, filtered, classified, or parsed, which may include generating one or more new data objects.

At operation 504 of FIG. 5, the automated customer assistance system 104 determine one or more attributes of the received legacy data and/or client data. In various embodiments, the attributes may include risk associated with the family business, which may include risks associated with the family business since its inception due having received both legacy data and client data. In various embodiments, the risk may include stakeholder risk, operational risk, financial risk, etc. The determination of attributes may be similar to operation 404 discussed above.

At operation 506 of FIG. 5, the automated customer assistance system 104 receives external data. As described herein, external data may be received from an external data source 110. In various embodiments, the external data may include brand value data or entity data related to one or more business entities associated with the client. In various embodiments, the external data may be data associated with one or more descendants or candidates for promotion within the family business (collectively referred to as a descendant). Such descendant data may be provided from external data sources 110 as social media platforms and/or other websites hosting information about the descendant. In various embodiments, the automated customer assistance system 104 may crawl or scrape websites for data associated with an identified descendant. In various embodiments, the external data may include data associated with competitors (e.g., competitor data) and/or the industry (e.g., industry data) that may be used in generating advisories addressing competition or the industry.

In various embodiments, the external data and/or external data objects received from external data sources 110 may be converted, filtered, classified, or parsed similar to the legacy data and/or legacy data objects discussed above.

At operation 508 of FIG. 5, the automated customer assistance system 104 generates a model based on one or more attributes, legacy data, and/or external data.

The automated customer assistance system 104 analyses the retrieved legacy business information, brand value, and risk information of the family business and generates a computational model based on determined risk, received brand value and business information, to determine a plurality of attributes related to the family business.

The system analyses the retrieved legacy business information, brand value, and risk information of the family business and generates a computational model based on determined risk, received brand value and business information, to determine a plurality of attributes related to the family business.

In various embodiments, the model may be generated to address a specific situation or type of risk identified by the client. In an example, the client may be faced with identifying a successor. The client may identify specific risks associated with identifying a successor or the automated customer assistance system 104 may automatically identify risks based on the determined attributes, legacy data, and client data. In various embodiments, these risks may include brand value risk, stakeholder risk, operational risk, financial risk, etc. In various embodiments, machine learning may be used to generate the model.

The computational model can represent a variety of statistical information related to the family business.

At operation 510 of FIG. 5, the automated customer assistance system 104 applies the model to client data.

The workflow further comprises the steps of generating an analytical model based on determined risk, received brand value and business information, determining business capacity of one or more descendants.

The system further determines one or more descendants of the one or more owner of the family business by analyzing personal information.

The system also determines business capacity of one or more descendants based on respective personal profile and financial information of the one or more descendants.

At operation 512 of FIG. 5, the automated customer assistance system 104 generates a knowledge will. In various embodiments, the knowledge will may be generated dynamically, including being generated anew or being updated based on triggers. A trigger may be the receipt of new and/or additional data or a time (e.g., day of the week, or a set period of time elapsing). In various embodiments, the knowledge will may be based on future business strategies based on the analytical model and business capacity of the descendants.

In various embodiments, descendant data may be included in client data and/or may be included in data received from external sources. The descendant data may include business capacity data associated with or indicative of the business capacity of the descendants. For example, business capacity data may include data regarding a descendant's education, positions held, financial metrics associated with performance in the family business, success and/or failures in prior roles, business intelligence related to the family business or a roll in the family business, financial capacity.

In various embodiments, the knowledge will may be transmitted to one or more user devices 106. In various embodiments with more than one owner of the family business, the knowledge will may be transmitted to a user device 106 of each owner. For each recipient of a knowledge will, the automated customer assistance system 104 may format the knowledge will data object for display on each of the user devices 106. In various embodiments, the format may include changing the size of how data is displayed along with the format of displays. For example, some information in a knowledge will may be omitted, such as figures or detailed summaries of suggestions.

In various embodiments, the process 500 may be used to generate an advisory of a knowledge will. For example, a client may be challenged with determining which of two or more individuals to succeed the client in taking a new roll. The new roll may, in various embodiments, leading all of a client's family business or some or the family business, such as a division or a subsidiary. The client, however, may be unable to understand or contextualize the potential successor's experience. In various embodiments, the client may request an advisory of a knowledge will to determine the suitability of successor for the potential roll. As described herein, in various embodiments, an automated customer assistance system 104 may execute process 500 to generate a knowledge will. During process 500, the automated customer assistance system 104 may, among other things, receive legacy data associated with one or more ancestors as well as client data associated with the client for use in generating the knowledge will. The automated customer assistance system 104 may use a computational model via respective application for simulating different business scenarios and check on one or more of a plurality of statistical information, including but not limited to how an aggressive investment of certain amount of revenue enabled the ancestor and/or client to grow the family business historical in view of estimate challenges to arise in next 5 years. In various embodiments, growth may be determined in view of revenue, profit, company size, brand value, etc. The automated customer assistance system 104 may further determine how, for example, three successors, which may be referred to as ‘A’, ‘B’, and ‘C’, may be suited for running for the family business by analyzing data associated with each successor, including but not limited to data received from the client and external data sources. In various embodiments, data from external data sources may include personal information data and/or business capacity data. Examples of personal information data may include data indicators associated with a successors goals, such as successor ‘A’ being interested in business while successors ‘B’ and ‘C’ are interested in different professions. Example of business capacity data may include personal profile data and/or financial information data associated with personal and/or professional performance. In various embodiments, personal information data and business capacity data may be determined from data received from external data sources, which, as described herein, may require transformation, interpretation, and/or classification before it may be used by the automated customer assistance system 104. From the legacy data, client data, and external data, a model may be generated and when the model is applied to the client data the automated customer assistance system 104 may generate a knowledge will.

In various embodiments, a knowledge will may address sibling successor conflict. For example, social media information data may be used by the automated customer assistance system 104 to identify or determine data indicative of conflict between descendants. Such identifications or determinations may be made with natural language processing techniques that may identify data (e.g., social media posts) indicative of conflict. The automated customer assistance system 104 may include the identification of a conflict in the advisory along with a detailed explanation, which may include specific data used in the identification or determination.

In various embodiments where a rule set or model is provided to a client as a part of an advisory, the advisory may allow for the client to adjust the rule set, such as via user device 106. The adjustment to the rule set or model may then cause iterations of one or more operations of processes 400 and/or 500.

In various embodiments, the knowledge will may be transmitted to the client via the network for display on a user device 106. Additionally, the knowledge will may be interactive. In various embodiments, an interactive advisory of a knowledge will may present the client with multiple scenarios, allow the client to provide additional client data, iterate one or more operations of process 500 to update the knowledge will to incorporate the additional client data, and/or present and allow the client to select options to generate documents associated with succession. In various embodiments, documents associated with succession may include but are not limited to legal documents implementing a succession plan.

In various embodiments, a client may request a knowledge will be generated based on one or more attributes determined from client data and/or external data while omitting legacy data, either implicitly or expressly. After attributes have been determined and external data has been received, a knowledge will may be generated (as described herein) and the knowledge will may be transmitted to the client via the network for display on a user device 106. The display of the knowledge will may include a tree view of all business related to the client, including subdivisions and/or departments of each business, that may also display individuals at the client's business(es). In various embodiments, for each business, subdivision, and or department, an individual may be identified (e.g., tagged or indicated) as a successor for each level of the organization. When displayed to a client on a client device 106, a client may adjust where a successor may be, such as with drag and drop functionality, which would cause client device 106 to transmit feedback to the automated customer assistance system 104. In various embodiments, the knowledge will may be updated at various time periods and/or when an employee is added, such as during an onboarding process. In various embodiments, more than one individual may be identified as a successor, and when more than one individual is identified additional detailed information may be provided, such as with a weighting applied to each individual. A weighting may include an indication determined by the automated customer assistance system 104 related to a determined level of success and/or failure of achieving a client goal or client current performance and/or of success of an individual in a current and/or new position. A client may provide an indication to the automated customer assistance system 104 of a selection of an individual to finalize at one or more levels. Such an indication may cause the customer assistance system 104 to generate an updated advisory of a knowledge will or an individual upon the selection of one individual, or the update may be generated after selection of multiple individuals. In various embodiments, a client might select an individual and indicate the selection is to be valid for a time period or over various periods of time (e.g., first individual for first six months and second individual for after the first six months). In various embodiments, a knowledge will may be generated for each time period of a plurality of time periods.

In various embodiments, a client and/or stakeholder may be surveyed for external data of feedback. A survey may be transmitted by the automated customer assistance system 104 over network 102 to a client device 106 associated with one or more clients and/or stakeholders. A survey may be displayed on the client device 106, and allow for interaction by the client and/or stakeholder. An interaction may include feedback data of one or more selections of options in responses to a survey question and/or the input of one or more survey response data. The feedback data may be transmitted from the client device 106 over network 102 and received by the automated customer assistance system 104 as external data, which is then used in the generation of an advisory as discussed herein. In various embodiments, the receipt of feedback data and/or the responses in the feedback data may trigger an update of an advisory. In various embodiments, a survey may the transmitted to clients and/or stakeholder based on the determination of one or more attributes, the defining of a rule set, and or the generation of a model, which may request additional data. Feedback, including selections made by a client and/or stakeholder, may be transmitted to the automated customer assistance system 104 in a feedback data object, which may include data identifying the client associated with providing the feedback data as well as other information associated with the data used to generate the knowledge will, including but not limited to filtering, classification, and/or format of such data, which may be used in, for example, iterations one or more operations described herein.

In various embodiments, a survey may be triggered based on external data of a social sentiment attribute that may be determined by the automated customer assistance system 104. The external data may be received from one or more social media sources, which may include reactions to an announcement, such as a product launch, a social media post, a naming of a successor for a position at the client, a financial disclosure (e.g., earning announcement), a specific time, etc. In various embodiments, a client may design and submit a survey to be used by the automated customer assistance system 104, which may include a designation of one or more triggers. In various embodiments, the automated customer assistance system 104 may filter, classify, and/or determine an attribute at an organization level, subdivision level, or individual level, such as, but not limited to, a social sentiment attribute.

In an exemplary embodiment, an automated customer assistance system may generate an advisory of a knowledge will where social sentiment along with profitability estimate determined is transmitted to a client for two successors: “Your successor 1 is financially profitable at 50% with a social sentiment score of 5 out of 10. Your successor 2 is financially profitable at 30% with a social sentiment at 30%.” Additionally, a survey may be transmitted to the one or more clients receiving the advisory, and the survey may allow for a client to provide feedback with agree, disagree, or adjustment to the advisory, such as more or less of a percentage being attributable to an individual, which may be provided to the automated customer assistance system 104, which may regenerate the advisory.

### CONCLUSION

Although exemplary systems and exemplary methods have been described above, implementations or embodiments of the subject matter and the operations described herein can be implemented in other types of digital electronic circuitry, computer software or program, firmware, or hardware, including the structures disclosed in this specification and their structural equivalents, or in combinations of one or more of them.

Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” as used above encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing, and grid computing infrastructures.

Computer software or computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A computer program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media, and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user device 106 in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a user device (e.g., for purposes of displaying information/data to and receiving user input from a user interacting with the user device). Information/data generated at the user device (e.g., a result of the user interaction) can be received from the user device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. An apparatus for providing automated customer assistance comprising a processor and a memory, the memory comprising instructions that configure the apparatus to:
receive, over a network, by communications circuitry, one or more legacy data objects associated with an ancestor, wherein the one or more legacy data objects use a first data format;
convert, by the processor, legacy data in the one or more legacy data objects to a second data format;
determine one or more legacy attributes associated with the one or more legacy data objects;
generate one or more machine learning training sets based on the one or more legacy attributes;
train one or more machine learning models with a first machine learning training set of the one or more machine learning training sets;
generate, by a first machine learning model of the one or more machine learning models, —a first rule set based on one or more historical actions in the one or more legacy attributes, wherein the first rule set comprises one or more strategic actions, and wherein the first rule set is configured to be adjustable by a user device;
receive, from the user device over the network, a business strategy indication and a historical evaluation indication associated with the ancestor;
receive one or more client data objects associated with a client, wherein the one or more client data objects use the second data format;
determine one or more suggestions based on the first rule set, the one or more client data objects, the business strategy indication, and the historical evaluation indication; and
generate an advisory based on the one or more suggestions.

2. (canceled)

3. The apparatus of claim 1, wherein the first data format is incompatible with being used in the one or more machine learning training sets.

4. The apparatus of claim 1, the memory further comprising instructions that configure the apparatus to:
generate a renderable object associated with the advisory; and
cause the renderable object to be displayed on a user interface of the user device.

5. The apparatus of claim 1, wherein converting the legacy data in the one or more legacy data objects includes optical character recognition.

6. The apparatus of claim 1, wherein the legacy data in the one or more legacy data objects is encrypted and converting the legacy data includes decrypting the legacy data.

7. The apparatus of claim 1, the memory further comprising instructions that configure the apparatus to:
receive, prior to determining the one or more suggestions, one or more external data objects from one or more external data sources, wherein external data comprised in the one or more external data objects is associated with one or more of social media information data, brand value data, business reputation data, or stakeholder data associated with the ancestor, and wherein the determining of the one or more suggestions is further based on the external data comprised in the one or more external data objects.

8. A computer program product comprising at least one non-transitory computer-readable storage medium having computer-executable program code instructions stored therein, the computer-executable program code instructions comprising program code instructions configured to:
receive, over a network, by communications circuitry, one or more legacy data objects associated with an ancestor, wherein the one or more legacy data objects use a first data format;
convert legacy data in the one or more legacy data objects to a second data format;
determine one or more legacy attributes associated with the one or more legacy data objects;
generate one or more machine learning training sets based on the one or more legacy attributes;
train one or more machine learning models with a first machine learning training set of the one or more machine learning training sets;
generate, by a first machine learning model of the one or more machine learning models, a first rule set based on one or more historical actions in the one or more legacy attributes, wherein the first rule set comprises one or more strategic actions, and wherein the first rule set is configured to be adjustable by a user device;
receive, from the user device over the network, a business strategy indication and a historical evaluation indication associated with the ancestor;
receive one or more client data objects associated with a client, wherein the one or more client data objects use the second data format;
determine one or more suggestions based on the first rule set, the one or more client data objects, the business strategy indication, and the historical evaluation indication; and
generate an advisory based on the one or more suggestions.

9. (canceled)

10. The computer program product of claim 8, wherein the first data format is incompatible with being used in the one or more machine learning training sets.

11. The computer program product of claim 8, wherein the computer-executable program code instructions comprising the program code instructions are further configured to:
generate a renderable object associated with the advisory; and
cause the renderable object to be displayed on a user interface of the user device.

12. The computer program product of claim 8, wherein converting the legacy data in the one or more legacy data objects includes optical character recognition.

13. The computer program product of claim 8, wherein the legacy data in the one or more legacy data objects is encrypted and converting the legacy data includes decrypting the legacy data.

14-20. (canceled)

21. The apparatus of claim 1, wherein the legacy data comprises one or more of historical financial information data, historical transaction data, business strategy data, business reputation data, social information data, or personal information data associated with the ancestor.

22. The apparatus of claim 1, wherein the one or more legacy attributes comprise one or more of a business style, business domain knowledge, stakeholder identity, stakeholder type, stakeholder relationship, stakeholder risk, strategy failure pattern, risk tolerance, investment pattern, transaction style, payment habit, transaction context, situational business strategy, failure patterns, business brand value, business market review, average turnover, revenue, liability, expenditure history associated with the ancestor.

23. The apparatus of claim 1, wherein the instructions to generate the advisory based on the one or more suggestions further configure the apparatus to:
determine, prior to generating the advisory, a first advisory format of a plurality of advisory formats, wherein the first advisory format is associated with a first user authority level;
determine, based on the first user authority level, one or more of a subset of suggestions of the one or more suggestions or a subset of strategic actions of the one or more strategic actions to be included in the advisory;
generate the advisory based on one or more of the subset of suggestions or the subset of strategic actions; and
transmit the advisory to a first user device of a first user of a plurality of users, wherein the first user is associated with the first user authority level.

24. The apparatus of claim 1, the memory further comprising instructions that configure the apparatus to:
receive, from the user device, an adjustment to the first rule set;
generate a second rule set based on the adjustment to the first rule set;
generate a second machine learning training set, wherein generating the second machine learning training set comprises updating the first machine learning training set based on the second rule set; and
train the first machine learning model of the one or more machine learning models based on the second machine learning training set.

25. The computer program product of claim 8, wherein the legacy data comprises one or more of historical financial information data, historical transaction data, business strategy data, business reputation data, social information data, or personal information data associated with the ancestor.

26. The computer program product of claim 8, wherein the one or more legacy attributes comprise one or more of a business style, business domain knowledge, stakeholder identity, stakeholder type, stakeholder relationship, stakeholder risk, strategy failure pattern, risk tolerance, investment pattern, transaction style, payment habit, transaction context, situational business strategy, failure patterns, business brand value, business market review, average turnover, revenue, liability, expenditure history associated with the ancestor.

27. The computer program product of claim 8, wherein the program code instructions to generate the advisory based on the one or more suggestions are further configured to:
determine, prior to generating the advisory, a first advisory format of a plurality of advisory formats, wherein the first advisory format is associated with a first user authority level;
determine, based on the first user authority level, one or more of a subset of suggestions of the one or more suggestions or a subset of strategic actions of the one or more strategic actions to be included in the advisory;
generate the advisory based on one or more of the subset of suggestions or the subset of strategic actions; and
transmit the advisory to a first user device of a first user of a plurality of users, wherein the first user is associated with the first user authority level.

28. The computer program product of claim 8, wherein the program code instructions are further configured to:
receive, from the user device, an adjustment to the first rule set;
generate a second rule set based on the adjustment to the first rule set;
generate a second machine learning training set, wherein generating the second machine learning training set comprises updating the first machine learning training set based on the second rule set; and
train the first machine learning model of the one or more machine learning models based on the second machine learning training set.

29. A computer-implemented method for providing automated customer assistance, the computer-implemented method comprising:
receiving, over a network, by communications circuitry, one or more legacy data objects associated with an ancestor, wherein the one or more legacy data objects use a first data format;
converting, by a processor, legacy data in the one or more legacy data objects to a second data format;
determining one or more legacy attributes associated with the one or more legacy data objects;
generating one or more machine learning training sets based on the one or more legacy attributes;
training one or more machine learning models with a first machine learning training set the one or more machine learning training sets;
generating, by a first machine learning model of the one or more machine learning models, a first rule set based on one or more historical actions in the one or more legacy attributes, wherein the first rule set comprises one or more strategic actions, and wherein the first rule set is configured to be adjustable by a user device;
receiving, from the user device over the network, a business strategy indication and a historical evaluation indication associated with the ancestor;
receiving one or more client data objects associated with a client, wherein the one or more client data objects use the second data format;
determining one or more suggestions based on the first rule set, the one or more client data objects, the business strategy indication, and the historical evaluation indication; and
generating an advisory based on the one or more suggestions.
